(19) United States
(12) Patent Application Publication
(10) Pub. No.: US 2015/0341742 A1
(43) Pub. Date: Nov. 26, 2015

(54) TRANSMISSION OF MOTION DATA

(71) Applicants: Canfeng CHEN, (US); Jia LIU, (US)

(72) Inventors: Canfeng CHEN, Beijing (CN); Jia LIU, Beijing (CN)

(21) Appl. No.: 14/442,369

(22) PCT Filed: Nov. 16, 2012
(86) PCT No.: PCT/CN2012/084746

§ 371 Date: May 12, 2015

(51) Int. Cl. H04W 4/00; G06F 3/038; G06F 1/16; G06F 3/0346

(52) U.S. Cl. CPC H04W 4/006; G06F 3/0346; G06F 3/038; G06F 1/1694; G06F 2203/0384

(57) ABSTRACT

An apparatus comprises at least one processor and at least one non-transitory memory medium having computer-readable code stored thereon, the computer-readable code together with the at least one processor causing the apparatus: to include motion data based on at least one signal generated by at least one motion sensor in a message portion, the message portion comprising a first field and a second field, the motion data being included in the second field of the message portion; to include signalling data in the first field of the message portion, the signalling data being for indicating a type of the motion data included in the second field; and to cause the message portion to be transmitted wirelessly to a recipient device.

### FIELD

The invention relates to the transmission of motion data.

### BACKGROUND

Many modern portable devices support wireless communication, such as Wi-Fi, Bluetooth Zigbee and the like. Some of those devices also include motion sensors.

### SUMMARY

In a first aspect, this specification describes apparatus comprising at least one processor and at least one non-transitory memory medium having computer-readable code stored thereon, the computer-readable code together with the at least one processor causing the apparatus: to include motion data based on at least one signal generated by at least one motion sensor in a message portion, the message portion comprising a first field and a second field, the motion data being included in the second field of the message portion; to include signalling data in the first field of the message portion, the signalling data being for indicating a type of the motion data included in the second field; and to cause the message portion to be transmitted wirelessly to a recipient device.

The computer-readable code together with the at least one processor may cause the apparatus to detect a change in the signal generated by the at least one motion sensor; and to respond to the detection by: including the motion data in the second field; including the signalling data in the first field; and causing the message portion to be transmitted to the recipient device.

The computer-readable code together with the at least one processor may cause the apparatus: to respond to receipt of a request from the recipient device by: the motion data in the second field; including the signalling data in the first field; and causing the message portion to be transmitted to the recipient device.

The computer-readable code together with the at least one processor may cause the apparatus to include auxiliary data in the message portion, the auxiliary data relating to the motion data. The computer-readable code together with the at least one processor may cause the apparatus to include the auxiliary data in the second field of the message portion. The computer-readable code together with the at least one processor may cause the apparatus to include, in the first field, signalling data for indicating the presence, in the second field, of the auxiliary data. The signalling data for indicating the presence of the auxiliary data may be configured to indicate a type of the auxiliary data.

The signalling data may be configured to indicate a number of axes of motion to which the motion data relates.

The motion data may comprise plural types of motion data, the plural types of motion data being based on signals generated by plural types of motion sensor, and wherein the signalling data may be configured to indicate the types and locations in the second field of each of the plural types of motion data. The signalling data may comprise plural pairs of data bits and wherein each pair of data bits may correspond to a different type of motion data. Each pair of data bits may be for indicating the number of axes of motion to which the corresponding type of motion data relates. The plural types of motion sensor may include at least two of an accelerometer, a gyroscope and a magnetometer.

The message portion may be caused to be transmitted as part of a Bluetooth low energy message.

The apparatus may be a portable communication device comprising the at least one motion sensor.

In a second aspect, this specification describes apparatus comprising at least one processor and at least one non-transitory memory medium having computer-readable code stored thereon, the computer-readable code together with the at least one processor causing the apparatus: to enable wireless receipt from a motion detection device of a message portion, the message portion including a first field and a second field, the second field including motion data indicative of motion of the motion detection device and the first field including signalling data for indicating a type of the motion data included in the second field; and to use the signalling data to interpret the motion data.

The computer-readable code together with the at least one processor may cause the apparatus, prior to enabling wireless receipt of the message portion, to cause transmission to the motion detection device of a request for motion data indicative of the motion of the motion detection device.

In a third aspect, this specification describes a method comprising: including motion data based on at least one signal generated by at least one motion sensor in a message portion, the message portion comprising a first field and a second field, the motion data being included in the second field of the message portion; including signalling data in the first field of the message portion, the signalling data being for indicating a type of the motion data included in the second field; and causing the message portion to be transmitted wirelessly to a recipient device.

The method may comprise detecting a change in the signal generated by the at least one motion sensor, and responding to the detection by: including the motion data in the second field; including the signalling data in the first field; and causing the message portion to be transmitted to the recipient device. The method may comprise responding to receipt of a request from the recipient device by: including the motion data in the second field; including the signalling data in the first field; and causing the message portion to be transmitted to the recipient device.

The method may comprise including auxiliary data in the message portion, the auxiliary data relating to the motion data. The method may comprise including the auxiliary data in the second field of the message portion. The method may comprise including, in the first field, signalling data for indicating the presence, in the second field, of the auxiliary data. The signalling data for indicating the presence of the auxiliary data may be configured to indicate a type of the auxiliary data.

The signalling data may be configured to indicate a number of axes of motion to which the motion data relates.

The motion data may comprise plural types of motion data, the plural types of motion data being based on signals generated by plural types of motion sensor, and wherein the signalling data may be configured to indicate the types and locations in the second field of each of the plural types of motion data. The signalling data may comprise plural pairs of data bits and wherein each pair of data bits corresponds to a different type of motion data. Each pair of data bits may be for indicating the number of axes of motion to which the corresponding type of motion data relates. The plural types of motion sensor may include at least two of an accelerometer, a gyroscope and a magnetometer. The method may comprise causing the message portion to be transmitted as part of a Bluetooth low energy message.

In a fourth aspect, this specification describes a method comprising: enabling wireless receipt from a motion detection device of a message portion, the message portion including a first field and a second field, the second field including motion data indicative of motion of the motion detection device and the first field including signalling data for indicating a type of the motion data included in the second field; and using the signalling data to interpret the motion data.

The method may comprise, prior to enabling wireless receipt of the message portion, causing transmission to the motion detection device of a request for motion data indicative of the motion of the motion detection device.

In a fifth aspect, this specification describes at least one non-transitory computer-readable memory medium having computer-readable code stored thereon, the computer-readable code being configured to cause computing apparatus: to include motion data based on at least one signal generated by at least one motion sensor in a message portion, the message portion comprising a first field and a second field, the motion data being included in the second field of the message portion; to include signalling data in the first field of the message portion, the signalling data being for indicating a type of the motion data included in the second field; and to cause the message portion to be transmitted wirelessly to a recipient device.

In a sixth aspect, this specification describes at least one non-transitory computer-readable memory medium having computer-readable code stored thereon, the computer-readable code being configured to cause computing apparatus: to enable wireless receipt from a motion detection device of a message portion, the message portion including a first field and a second field, the second field including motion data indicative of motion of the motion detection device and the first field including signalling data for indicating a type of the motion data included in the second field; and to use the signalling data to interpret the motion data.

In a seventh aspect, this specification describes computer-readable code which, when executed by computing apparatus, causes the computing apparatus to perform a method according to either of the first and second aspects.

In an eighth aspect, this specification describes apparatus comprising: means for including motion data based on at least one signal generated by at least one motion sensor in a message portion, the message portion comprising a first field and a second field, the motion data being included in the second field of the message portion; means for including signalling data in the first field of the message portion, the signalling data being for indicating a type of the motion data included in the second field; and means for causing the message portion to be transmitted wirelessly to a recipient device.

In a ninth aspect, this specification describes apparatus comprising: means for enabling wireless receipt from a motion detection device of a message portion, the message portion including a first field and a second field, the second field including motion data indicative of motion of the motion detection device and the first field including signalling data for indicating a type of the motion data included in the second field; and means for using the signalling data to interpret the motion data.

In a tenth aspect, this specification describes apparatus configured: to include motion data based on at least one signal generated by at least one motion sensor in a message portion, the message portion comprising a first field and a second field, the motion data being included in the second field of the message portion; to include signalling data in the first field of the message portion, the signalling data being for indicating a type of the motion data included in the second field; and to cause the message portion to be transmitted wirelessly to a recipient device.

In an eleventh aspect, this specification describes apparatus configured: to enable wireless receipt from a motion detection device of a message portion, the message portion including a first field and a second field, the second field including motion data indicative of motion of the motion detection device and the first field including signalling data for indicating a type of the motion data included in the second field; and to use the signalling data to interpret the motion data.

### BRIEF DESCRIPTION OF THE FIGURES

For a more complete understanding of example embodiments, reference is now made to the following description taken in connection with the accompanying drawings in which:

FIG. 1 is a schematic illustration of a system according to example embodiments;

FIG. 2 is a schematic illustration of a structure of a portion of a wireless message according to example embodiments;

FIG. 3 is a schematic illustration of a first field of the wireless message portion of FIG. 2;

FIG. 4 is a schematic illustration of a second field of the wireless message portion of FIG. 2;

FIGS. 5A, 5B and 5C are examples of structures of wireless message portions according to example embodiments;

FIG. 6 is a flow chart illustrating an example method which may be performed by the motion detection apparatus of FIG. 1; and

FIG. 7 is a flow chart illustrating an example method which may be performed by the wireless communication apparatus of FIG. 1.

### DETAILED DESCRIPTION OF EXAMPLES

In the description and drawings, like reference numerals refer to like elements throughout.

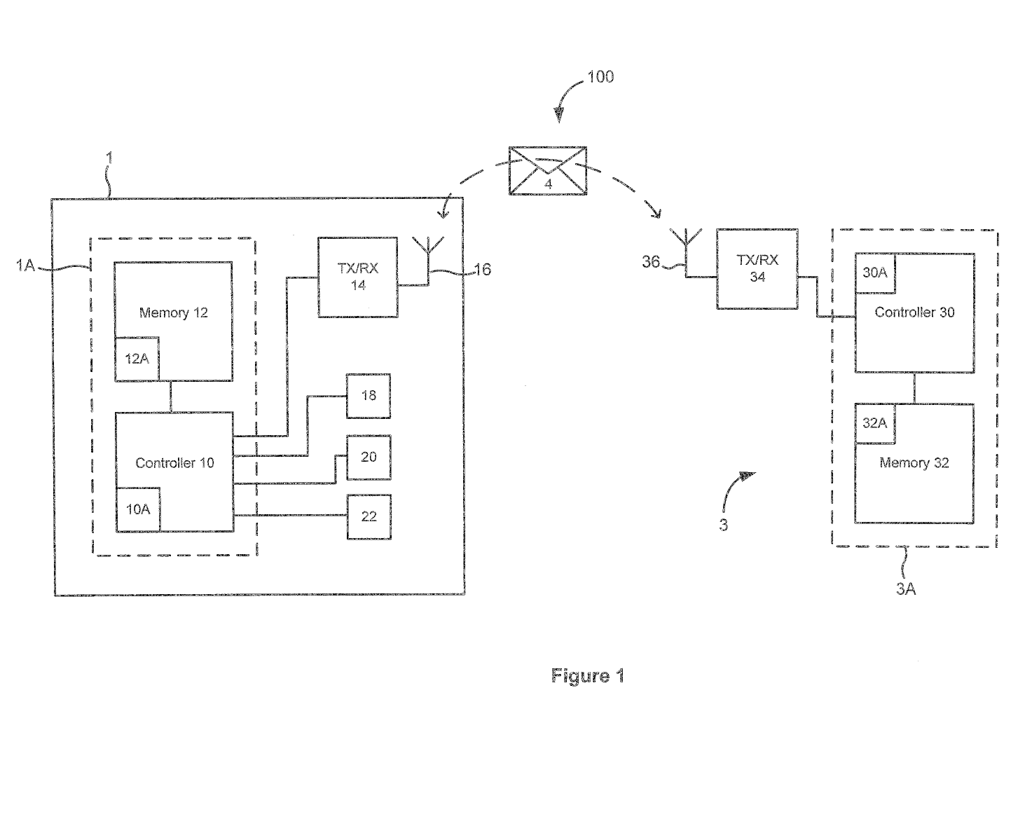

FIG. 1 is a schematic illustration depicting a wireless communication system too according to example embodiments. In the example of FIG. 1, the wireless communication system too comprises motion detection apparatus 1 and wireless communication apparatus 3 for communicating wirelessly with the motion detection apparatus 1.

The motion detection apparatus 1 comprises control apparatus 1A. The control apparatus 1A comprises a controller 10 and at least one non-transitory memory medium 12. The controller 10 is operable to perform operations under the control of computer-readable code 12A stored in the at least one memory 12. The controller 10 is operable to retrieve data from the memory 12 and also to store data therein.

The motion detection apparatus 1 comprises at least one transceiver 14. The at least one transceiver 14 is operable under the control of the controller 10 to transmit wireless communication data packets, via an antenna 16. These data packets may be created by controller 10. The at least one transceiver 14 is operable also to receive wireless communication data packets via the antenna 16. Received data packets are passed to the controller 10 which is operable to process them and to respond accordingly.

The motion detection apparatus 1 comprises at least one motion sensor 18, 20, 22 for detecting motion of the motion detection apparatus 1 and for providing signals which are indicative of the detected motion of the apparatus 1. In some examples, the at least one sensor 18, 20, 22 comprises at least one of an accelerometer 18, a gyroscope 20 and a magnetometer 22. In the example of FIG. 1, the motion detection apparatus 1 is an inertial navigation system and comprises an accelerometer 18, a gyroscope zo and a magnetometer 22.

The accelerometer 18 is configured to detect linear acceleration of the apparatus or device in which it is located and to output signals indicative of the detected linear acceleration. The gyroscope 20 is configured to detect angular acceleration of the apparatus or device in which it is located and to output signals indicative of the detected angular acceleration (which is also known as angular rate). The magnetometer 22 is configured to measure the direction of the Earth's magnetic field relative to its current orientation and to output signals indicative of the direction. As the orientation of the device or apparatus, in which the magnetometer 22 is provided, changes, so too does the direction of the Earth's magnetic field relative to the magnetometer. As such, the magnetometer 22 is able to detect a change in orientation (i.e. motion) of the motion detection apparatus 1.

One or more of the sensors 18, 20, 22 is operable detect tri-axial motion and to output signals indicative of the tri-axial motion. In some examples, each of the sensors 18, zo, 22 is operable to detect tri-axial motion. One or more of the sensors 18, 20, 22 may comprise micro-electro-mechanical systems (MEMS). Two or more MEMS sensors 18, 20, 22 may be incorporated into a single microchip.

The controller 10 is communicatively coupled to each of the at least one motion sensors 18, 20, 22 such that it receives signals output therefrom. The controller 10 is operable to create motion data (or information) based on signals output by one or more of the motion sensors 18, 20, 22. The controller 10 is operable also to include the motion data in a wireless communication message portion 4. The controller 10 is operable also to cause the wireless communication message portion 4 to be transmitted to recipient apparatus (e.g. wireless communication apparatus 30).

In some examples, the controller 10 is operable detect a change in one or more of the signals generated by the at least one sensor 18, 20, 22. The controller 10 is operable to respond to the detected change by creating the motion data, including the motion data in the wireless message portion 4 and by causing the wireless message portion 4 to be transmitted to the recipient apparatus 3. In this way, messages may be created and transmitted only when there has been a change in motion. As such, the total amount of wireless communication may be reduced. The controller is operable also to respond to a request received from the wireless communication apparatus 3 by creating and causing transmission of a wireless message portion 4 including the motion data.

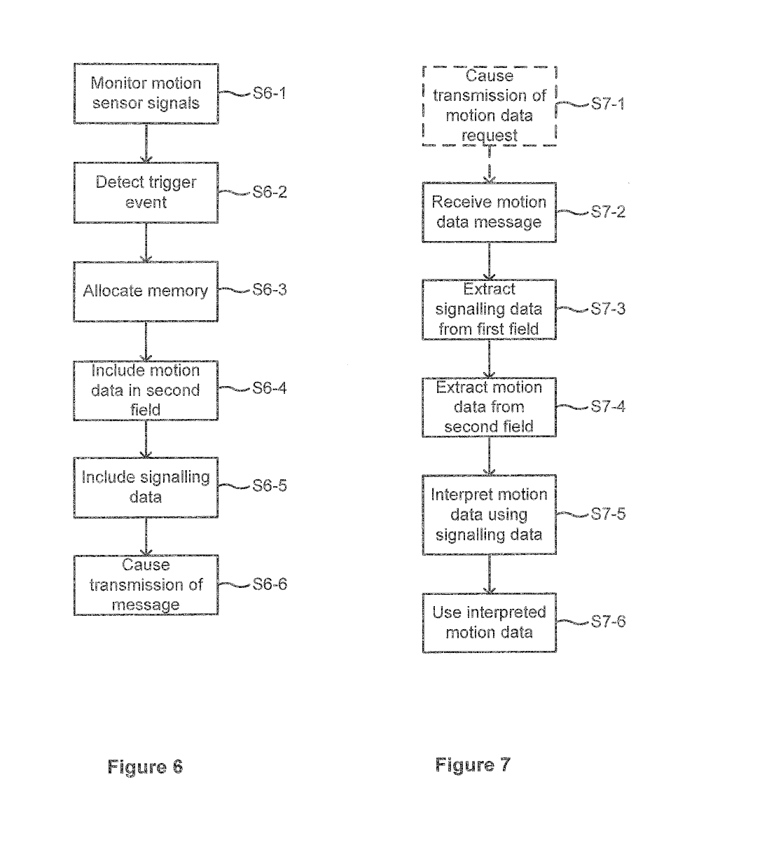

The wireless communication apparatus 3 is configured to communication wirelessly with the motion detection apparatus 1. The wireless communication apparatus comprises processing apparatus 3A, a transceiver module 34 and an antenna 36. The processing apparatus 3A comprises a controller 30 and at least one non-transitory memory 32. The controller 30 is operable to perform operations under the control of so computer-readable code 32A stored in the at least one memory 32. The controller 30 is operable to retrieve data from the memory 32 and also to store data therein. The controller 30 is operable also to cause the transceiver module 34 to transmit wireless messages to the motion detection apparatus 1. The transmitted wireless messages may include requests for information regarding detected motion. The controller 30 is operable also to extract the motion information from the wireless messages which are received from the motion detection apparatus 1, via the antenna 36 and the transceiver module 34. The controller 30 may be operable to use the extracted motion information to determine movement, and optionally also location of the motion detection apparatus 1. This and other example implementations of embodiments of the invention are discussed below with respect to FIG. 7.

The controllers 10, 30 of the motion detection apparatus 1 and the wireless communication apparatus 3 each comprise at least one processor 10A, 30A. The at least one processor 10A, 30A may comprise one or more different types of data processing means, such as but not limited to processor and microprocessors. The controllers 10, 30 may also comprise one or more application-specific integrated circuits (ASICs) (not shown). The at least one non-transitory memory media 12, 32, which are coupled to their respective at least one processor 10A, 32A, may include any suitable type, or combination of suitable types, of volatile or non-volatile memory medium. Suitable types of memory medium include, but are not limited to ROM, RAM and flash memory. It will of course be understood that the controllers 10, 30 and/or the memory 12, 32 of the motion detection apparatus 1 and the wireless communication apparatus 3 may be different to one another.

The transceivers 14, 34 of the motion detection apparatus 1 and the wireless communication apparatus 3 may be configured to transmit and receive Bluetooth low energy (BTLE) data packets or messages. In such examples, the motion detection apparatus 1 and the wireless communication apparatus 3 are configured to operate in accordance with the Bluetooth V4.0 specification. In other examples, the motion detection apparatus 1 and the wireless communication apparatus 3 may be configured to transmit and receive wireless messages using other wireless communication protocols, such as ZigBee, Bluetooth and Wi-Fi.

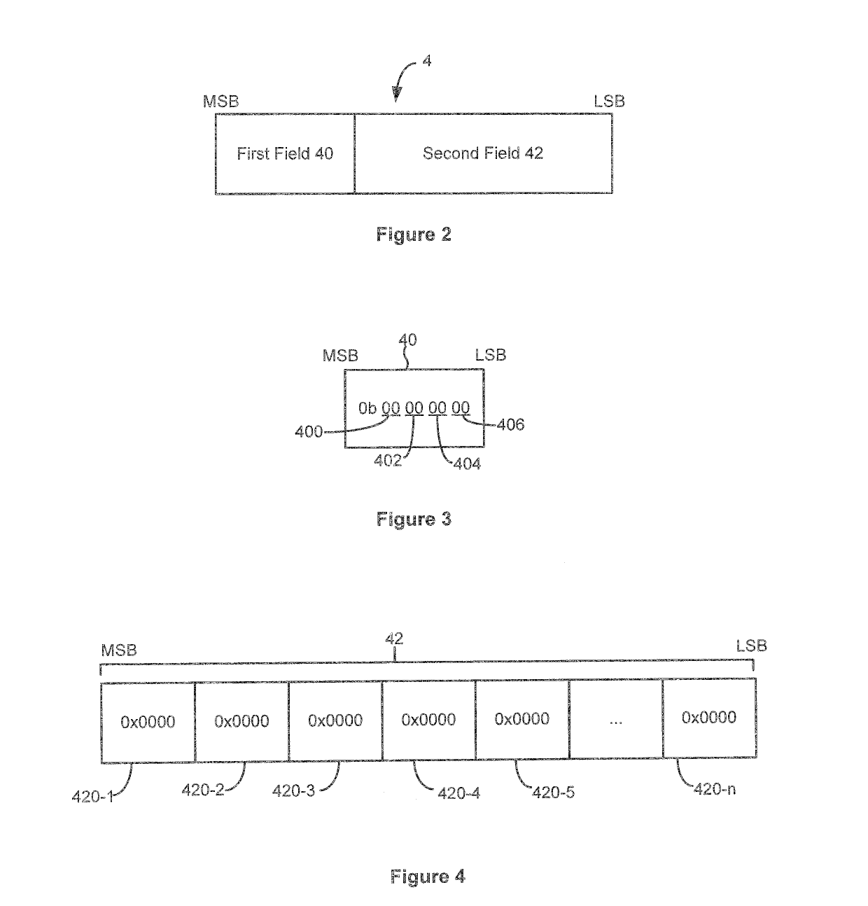

FIG. 2 is a schematic illustration of an example structure of a portion 4 of a wireless message, which may be transmitted by the motion detection apparatus 1 to the wireless communication apparatus 3. The wireless message portion 4 comprises a first field 40 and a second field 42. In some examples, the wireless message 4 comprises a binary number made up of a string of plural octets. In order not to cause ambiguity, the bit ordering when defining packets and messages in this specification follows the “Big Endian” format (see, for example, http://en.wikipedia.org/wiki/Endianness). This means that the least significant bit (LSB) corresponds to b₀, the most significant bit (MSB) is the first bit sent over the air, and the LSB is the last bit sent over the air. For instance, a 3-bit parameter X=3 (i.e., written in binary, b₂ b₁ b₀ . . . 011) is sent by b₂ b₁ b₀=011 over the air, where 0 (b₂, MSB) is sent first and 1 (b₀, LSB) is sent last. In the figures of this specification, the MSB is shown on the left-hand side, and LSB is shown on the right-hand side.

The controller 10 of the motion detection apparatus 1 is configured to create, based on signals received from the at least one motion sensor 18, 20, 22, motion data and to include this data in the second field 42 of the wireless message portion 4. The second field 42 may thus be referred to as the “motion data field”. In addition, the controller 10 is configured to create data for indicating the type of the motion data in the motion data field 42. This may be referred to as signalling data. The controller 10 is configured subsequently to include this data, which may also be referred to as motion indication data, in the first field of the 40 of the wireless message portion 4. The first field 40 may thus be referred to the “motion indication field”.

It will be appreciated that the wireless message portion 4 is shown in FIG. 2 may be supplemented, for example, by appropriate headers and error correction portions before transmission by the motion detection apparatus 1.

The motion indication data is configured to indicate the type of the motion data in the data field. For example, the motion indication data may indicate that data derived from signals output by the accelerometer 18 is linear acceleration data. Similarly, the motion indication data may indicate that data derived from signals output by gyroscope zo is angular acceleration data and that data derived from signals output by the magnetometer 20 is magnetic field data. In addition, where the motion data field 42 includes two different types of data, the motion indication field 40 may be configured to indicate the locations in the motion data field 42 of the different types of data. The motion data field 42 may be configured also to indicate the number of dimensions to which the data of a particular type relates.

FIG. 3 is a schematic illustration of a motion indication field 40 of a wireless message portion 4 according to example embodiments. The motion indication field 40 comprises a first octet of the portion of the wireless message 4. Adjacent pairs of bits 400, 402, 404, 406 (referred to hereafter as a first pair 400 to a fourth pair 406 going from MSB to LSB) of the octet are configured to signal or indicate the presence or absence in the motion data field 42 of motion data of different types. Consequently, in this example, the motion data field 40 can be used to indicate the presence or otherwise of motion data of a maximum of four different types.

In motion detection apparatus 1, such as that of FIG. 1, which includes fewer than four types of sensors, one pair of bits may be allocated to each sensor 18, 20, 22 and the remaining pair(s) of bits may be reserved for future use or to signal the presence of auxiliary data relating to one or more of the different types of motion data. Each of the pairs of bits 402, 404, 406 which are allocated to indicate motion data (and not auxiliary data) is configured also to indicate the number of dimensions to which the motion data corresponding to that pair of bits relates. As such, the controller 10 can use the pairs of bits to indicate that the data of a particular type that is present in the motion data field 42 is three-dimensional (or three-axial or tri-axial), is two-dimensional or is one-dimensional. In addition, the pairs of bits can be used by the controller 10 to indicate that motion data of a particular type is not present in the motion data field. Each pair of bits has four possible combinations and, according to example embodiments, the combinations may correspond to particular indications as shown in Table 1 below:

TABLE 1

| Bits | Indication |
|---|---|
| 00 | Data type not present |
| 01 | 1-dimensional data |
| 10 | 2-dimensional data |
| 11 | 3-dimensional data |

According to some example embodiments, the first pair of bits 400 is allocated for indicating the presence and type of auxiliary data in the motion data field 42. Types of auxiliary data include sensitivity data, time data (e.g. a time stamp), priority, credibility, encryption or any other suitable type. The first pair of bits 400 may also be used to indicate the absence of auxiliary data from the motion data field (for example “00” may indicate that no auxiliary data is present in the motion data field).

The second to fourth pairs of bits 402, 404, 406 may be allocated to motion data derived from each of the sensors 18, 20, 22 of the motion detection apparatus 1 of FIG. 1. For example, the second pair of bits 402 may be allocated to indicate the presence of data derived from the accelerometer 18, the third pair of bits 404 may be allocated to indicate the presence of data derived from the gyroscope 20 and the fourth pair of bits 406 may be allocated to indicate the presence of data derived from the magnetometer 22.

FIG. 4 is a schematic illustration of the motion data field 42 of the portion of the wireless message 4. The motion data field 42 is constituted by a plurality of octets. In some examples, the motion data field 42 is constituted of at least two octets. In some examples, the motion data field may comprise between two and twenty-two octets. In the example of FIG. 4, the motion data field 42 is comprised of a plurality of pairs of octets 420-1 . . . 420-n. In the example of FIG. 4, the pairs of octets 420-1 . . . 420-n are represented in hexadecimal format.

The controller 10 of the motion detection apparatus 1 is configured to utilise one pair of octets for each dimension of motion data. For example, if the data derived from one of the sensors 18, 20, 22 is three-dimensional, the controller 10 includes the data which indicates motion in a first dimension in a first pair of octets 420-1, the data which indicates motion in a second dimension in a second pair of octets 420-2, and the data which indicates motion in the third dimensions in a third pair of octets 420-3. In some examples, for each of the motion data types, a first pair of octets (from MSB to LSB) is used to indicate X-axis data, a second pair of octets is used to indicate Y-axis data and a third pair of octets is used to indicate Z-axis data.

The controller 10 may be configured to include the data derived from the sensor(s) 18, 20, 22 in the pairs of octets 420-1 . . . 420-n in “two's compliment format”. In this way, the pairs of octets can be used to indicate both positive and negative values. For example, 0x0000 is equal to 0 (zero) MSB, 0x0001 is equal to +1 LSB and 0xFFFF is equal to −1 MSB.

In addition to the motion data, the motion data field 42 may also include auxiliary data. This may be included in one or more octets located at the end (from MSB to LSB) of the motion data field. As such, in the example of FIG. 4, if the auxiliary data was included in a pair of octets, it would be included in the pairs of octets denoted by reference 420-i, 420-i+1, 420-i+2, . . . , 420-n (2<i<=n).

As will be appreciated, the length of the motion data field depends on the number of different types of motion data, the number of dimensions of each motion data type and whether auxiliary data is included. This may vary from device to device and from message to message (for example, because only motion data of one particular type has changed). However, if recipient apparatus, such as the wireless communication apparatus 3 of FIG. 1, has knowledge of the how to interpret the signalling data of the motion indication field 40, it will be able also to interpret the data in the motion data field 42 regardless of the number of data types and dimensions included.

In some examples, the locations of the pairs of bits in the message indication field 40 indicate the location of the corresponding motion data in the motion data field 42. For example, if the second pair of bits 402 indicates the presence of motion data of type A, the motion data of type A will be included in earlier octet pairs 420 (e.g. a first three octet pairs 402-1, 402-2, 404-3) of the motion data field 42 than is motion data indicated by the third and fourth pairs of bits 404, 406 of the motion indication field. Similarly, if a third pair of bits 402 indicates the presence of motion data of type B, the motion data of type B will be included in earlier octet pairs 420 of the motion data field 42 than is motion data of a type indicated by the fourth pair of bits 406. It will thus be understood that, on receipt of the wireless message portion 4, the wireless communication apparatus 31 is configured, based on an examination of the motion indication field 40, to determine the type and dimension to which information in a specific octet relates. Although in this example earlier bit pairs of the first field 40 are used to indicate earlier octets in the second field 42, it will be appreciated that earlier bit pairs of the first field 40 may instead correspond to later octets in the second field 42.

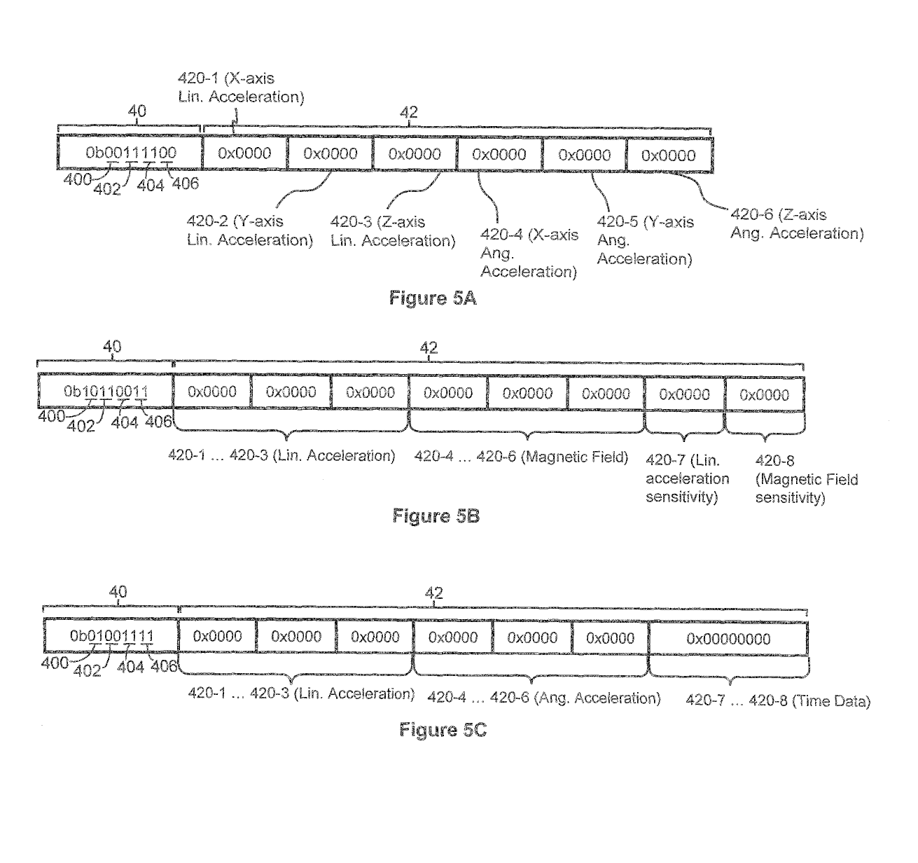

FIGS. 5A to 5C are schematic illustrations of three wireless messages portions carrying different combinations of motion data types.

In FIG. 5A, the wireless message portion 4 includes three-dimensional data derived from both the accelerometer 18 and the gyroscope 20. This can be understood from the motion indication field 40 in which the second pair of bits 402 (which, in this example, are associated with the accelerometer data) and the third pair of bits 404 (which, in this example, are associated with gyroscope data) are both set to “11”. The first pair of bits 400 (which, in this example, are associated with auxiliary data) are set to “00” and so indicate that no auxiliary data is present in the motion data field 42. The fourth pair of bits 406 (which, in this example, are associated with magnetometer data) are also set to “00” and so indicate that no magnetometer data is included in the motion data field 42.

The motion data field 420 includes six pairs of octets 420-1 . . . 420-6. The first three pairs of octets 420-1 . . . 420-3 respectively include X-, Y- and Z-axis data derived from the accelerometer 18. The subsequent three pairs of octets 420-4 . . . 420-6 respectively include X-, Y- and Z-axis data derived from the gyroscope 20. As mentioned above, the wireless communication apparatus 3 is able to ascertain this from an examination of the data in the motion indication field.

In FIG. 5B, the wireless message portion 4 includes three-dimensional data derived from both the accelerometer 18 and the magnetometer 22. This can be understood from the motion indication field 40 in which the second pair of bits 402 (which, in this example, are associated with the accelerometer data) and the fourth pair of bits 406 (which, in this example, are associated with magnetometer data) are both set to “11”. The first pair of bits 400 (which, in this example, are associated with auxiliary data) are set to “10”. This indicates that auxiliary data is present in the motion data field 42. In this example, the “10” state indicates that the auxiliary data is sensitivity data relating to the motion data. The third pair of bits 404 (which, in this example, are associated with gyroscope data) are set to “00” and so indicate that no gyroscope-derived data is included in the motion data field 42.

The motion data field 42 includes eight pairs of octets 420-1 . . . 420-8. The first three pairs of octets 420-1 . . . 420-3 respectively include X-, Y- and Z-axis data derived from the accelerometer 18. The subsequent three pairs of octets 420-4 . . . 420-6 respectively include X-, Y- and Z-axis data derived from the magnetometer 22. The seventh pair of octets 420-7 include sensitivity data related to the accelerometer-derived data and the eighth pair of octets 420-8 include sensitivity data related to the magnetometer derived data. The inclusion of sensitivity data in the message portion 4 allows the wireless communication apparatus 3 to correctly interpret motion data from different types of motion detection apparatuses, even if the sensitivity of the sensors vary from one apparatus to the next.

In FIG. 5C, the wireless message portion 4 includes three-dimensional data derived from both the accelerometer 18 and the gyroscope 20. This can be understood from the motion indication field 40 in which the second pair of bits 402 (which, in this example, are associated with the accelerometer data) and the third pair of bits 404 (which, in this example, are associated with gyroscope data) are both set to “ii”. The first pair of bits 400 (which, in this example, are associated with auxiliary data) are set to “01”. This indicates that auxiliary data is present in the motion data field 42. In this example, the “01” state indicates that the auxiliary data is time data (e.g. a time stamp) relating to the motion data. The fourth pair of bits 406 (which, in this example, are associated with magnetometer data) are also set to “00” and so indicate that no magnetometer data is included in the motion data field 42.

The motion data field 420 includes eight pairs of octets 420-1 . . . 420-8. The first three pairs of octets 420-1 . . . 420-3 respectively include X-, Y- and Z-axis data derived from the accelerometer 18. The subsequent three pairs of octets 420-4 . . . 420-6 respectively include X-, Y- and Z-axis data derived from the gyroscope 20. The final four octets (i.e. the seventh and eighth pairs 420-7, 470-8) include time data.

In the examples of FIGS. 5B and 5C, each message portion 4 includes a single type of auxiliary data. However, it will be appreciated that the message portion 4 may include plural types of auxiliary data. For example, if the first bit pair 400 of the motion indication field 40 was set to “11” this may indicate the presence of both the sensitivity data and the time data. In other words, each bit of the first pair 400 may correspond to a different type of auxiliary data. In addition, if two types of auxiliary data are present, the auxiliary data type indicated by the first bit may be provided in earlier octets of the motion data field 42 than is the auxiliary data type that is indicated by the second bit of the first pair 400 (or vice versa). It is of course appreciated that if there are more than two types of auxiliary data, the motion indication field 40 may be extended in length by, for example, two or more bits.

FIGS. 6 and 7 are flow charts illustrating operations performed by the motion detection apparatus 1 and the recipient apparatus 3 respectively.

Referring first to FIG. 6A, in step S6-1, the controller 10 monitors signals provided by the at least one sensor 18, 20, 22 of the motion detection apparatus 1.

In step S6-2, the controller 10 detects the occurrence of trigger event. A trigger event may be, for example, receipt of a request for motion data from the wireless communication apparatus 3. Alternatively, the trigger event may be a detection of a change in one or more of the signals output by the sensor(s) 18, 20, 22. Such a change may be indicative of movement (or a change in movement) of the motion detection apparatus 3 having occurred.

In step S6-3, in response to detecting the occurrence of the trigger event, the controller 10 allocates a portion of the memory 12 for the message portion. The size of the allocated portion may depend on the size of the motion sensor data and, if necessary, the size of the auxiliary data.

Next, in step S6-4, the controller 10 includes motion information (or data), which is based on signals output by the sensor(s) 18, 20, 22, in the second field of the allocated message portion 4. This step may comprise the controller 10 copying the motion information from its current location (which may be for example, a buffer in the memory 12) into the second field of the allocated portion of the memory 12. This may require the controller 10 to obtain the address of the current location of the motion data. In addition, the controller 10 may create, or retrieve from memory 12, auxiliary data relating to the motion data. The auxiliary data is then inserted or included into the allocated memory portion. As discussed above, such auxiliary data may include, for example sensitivity data and/or timestamp data. The octets of motion data and auxiliary data are placed in the motion data field 42 in an order that is dictated by rules stored in the memory 12 as part of computer program code 12A.

Subsequently, in step S6-5, the controller 10 includes signalling data in the message portion. This comprises the controller 10 creating signalling (or motion indication) information or data corresponding to the created motion data. Creating the signalling data may comprise setting relevant bits of an octet of the motion indication field of the allocated memory portion to “1” so as to indicate the nature (e.g. type and dimension) of the motion data.

Finally, in step S6-6, the controller 10 causes the transceiver 14 to transmit the message portion 4 as part of a wireless message to the wireless communication device 3 via the antenna 16. This may include placing the message portion 4 as a payload into a lower layer (for example, a transport layer) for transmission.

It will of course be appreciated that the above method is only an example of operations that may be performed by the motion detection device 1 of example embodiments and that the message portion 4 may be created and transmitted in any suitable way.

FIG. 7 is a flow chart illustrating operations which may be performed by the wireless communication device 3 of FIG. 1.

In step S7-1, the controller 30 causes a request for motion information to be transmitted by the transceiver 34 to the motion detection apparatus 1 via the antenna 36. As will be understood, in embodiments in which the motion detection apparatus 1 transmits the wireless message portion 4 in response to detection of a change in motion of the apparatus, step S7-1 may be omitted.

In step S7-2, the wireless communication apparatus 3 receives the wireless message, which includes the message portion 4 shown in FIG. 2, (transmitted in step S6-8) from the motion detection apparatus 1.

Next, the controller 30 extracts the data from the message portion 4. Specifically, in step S7-3, the controller 30 extracts data from the motion indication field 40 and in step, S7-4, the controller 30 extracts the data from the motion data field 42.

After data extraction, in step S7-5, the controller 10 uses the extracted motion indication data in conjunction with a set or rules stored in the memory 32 to interpret the motion data extracted from the motion data field 42. The stored rules may indicate for example, which bits pairs of the signalling data correspond to which type of data and which configurations of each pair correspond to which number of axes of motion. In some examples, this operation comprises examining which bits of the motion indication octet are set to “1” and, based on this examination, determining the type and dimension of motion to which the various octets of the motion data field relate.

Finally, in step S7-6, the controller 10 uses the interpreted motion data. The way in which the data is used may depend on the natures of the motion detection apparatus and the wireless communication apparatus 3. For example, where the motion detection apparatus 1 is for example a portable communication device (such as, but not limited to, a smart phone, a tablet computer and a navigation device), and the wireless communication system 3 is a location determination system, the motion data may be used for determining a direction of movement and/or a location of the portable device. In examples, in which the motion detection apparatus 3 is used as a controller 10 for a video game and the wireless communication apparatus is, for example, a games console or a PC, the received motion data may be used to control the operation of the video game. In other examples, the motion detection apparatus 1 may be incorporated into a stylus and the wireless communication apparatus may be incorporated into a computer (e.g. a tablet computer). In such examples, the motion data may be used by the computer for handwriting recognition. Other implementations of example embodiments include virtual reality implementations such as, but not limited to, trajectory tracking and virtual sculpture. Example embodiments may also be used in appliances and toys for a wide range of applications ranging from handwriting recognition to remote piloting of vehicles.

Once again, it will be appreciated that method of FIG. 7 is only an example of operations that may be performed by the wireless communication device 3. As such, the order in which steps are performed may be different, certain steps may be omitted and other steps may be included.

As mentioned briefly above, the motion detection apparatus 1 and the wireless communication apparatus 3 may be configured to communicate using Bluetooth low energy (BTLE). In such examples, the message portion 4 may be transmitted as part of a BTLE message of a new service for BTLE. The BTLE service is hereafter referred to as a 3D Motion Service. The 3D Motion Service may be implemented using the Generic Attribute (GATT) Profile described in the Bluetooth V4.0 specification. Examples of the characteristics and properties of the 3D Motion Service are shown in Table 2 below. The properties are listed in the top-most row and the characteristics are listed in the left-most column. In the table, an “M” indicates that a property is mandatory for the characteristic, an “O” indicates that the property is optional for the characteristic and an “X” indicates that a property is not-supported for that characteristic.

TABLE 2

| | | | Write | | | | Signed | Reliable | Writable |
|---|---|---|---|---|---|---|---|---|---|
| | Broadcast | Read | without | Write | Notify | Indicate | Write | Write | Auxiliaries |
| Linear | X | M | X | X | ◯ | X | X | X | X |
| Acceleration | | | | | | | | | |
| Angular | X | M | X | X | ◯ | X | X | X | X |
| Acceleration | | | | | | | | | |
| Magnetic | X | M | X | X | ◯ | X | X | X | X |
| Field | | | | | | | | | |
| Direction | | | | | | | | | |

In this example, the linear acceleration characteristic relates to data derived from accelerometer signals, the angular acceleration characteristic relates to data derived from gyroscope signals and the magnetic field direction characteristic relates to signals derived from a magnetometer.

The motion detection apparatus 3 (which may also be referred to as a “3D Motion Server”) is configured to create messages, including data relating to one or more of the characteristics, when a read request (which is based on the “GATT Read Characteristic Value” sub-procedure of the Bluetooth low energy V4.0 specification) is received from the wireless communication apparatus 3 (which may be referred to as the “Service Client”).

In addition, depending on the value of Client Characteristic Configuration descriptor, the 3D Motion Server may be configured to “notify” these characteristics to the Service Client when a change in the linear acceleration, the angular acceleration and/or the magnetic field direction is detected by the 3D Motion Server. This enables the Service Client to track the motion of the 3D Motion Server without constantly requesting the data.

Table 3, below, shows an example Attribute Database for the 3D Motion Service. In Table 3, UUID stands for universally unique identifier. As above “M” stands for mandatory and “0” stands for optional.

TABLE 3

| UUID | Permissions | M/O | Value (Default) |
|---|---|---|---|
| <<Primary Service>> | Read | M | <<3D Motion Service>> |
| <<Characteristic>> | Read | O | Properties = 0x12 (read, notify), Handle = |
| | | | Handle of Linear Acceleration, UUID = |
| | | | <<Linear Acceleration>> |
| <<Linear Acceleration>> | Read, Notify | O | Ref[Motion Data Format] |
| <<Client Characteristic | Read, Write | M | 0x0000 |
| Configuration>> | | | |
| <<Characteristic>> | Read | O | Properties = 0x12 (read, notify), Handle = |
| | | | Handle of Angular Acceleration, UUID = |
| | | | <<Angular Acceleration>> |
| <<Angular Acceleration>> | Read, Notify | O | Ref[Motion Data Format] |
| <<Characteristic>> | Read | O | Properties = 0x12 (read, notify), Handle = |
| | | | Handle of Magnetic Field Direction, |
| | | | UUID = <<Magnetic Field Direction>> |
| <<Magnetic Field | Read, Notify | O | Ref[Motion Data Format] |
| Direction>> | | | |

The above-described example of the 3D Motion Service provides an integrated and extensible way for transferring three-dimensional motion data via Bluetooth low energy. In addition, as described above, example embodiments described herein can be utilised with motion detection systems having different sensors and/or having different characteristics. Also, example embodiments described herein are backwardly compatible with traditional two-dimensional motion detection system (as they allow the transfer of data of one, two, or three dimensional motion data.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-36. (canceled)

37. Apparatus comprising at least one processor and at least one non-transitory memory medium having computer-readable code stored thereon, the computer-readable code together with the at least one processor causing the apparatus:
to include motion data based on at least one signal generated by at least one motion sensor in a message portion, the message portion comprising a first field and a second field, the motion data being included in the second field of the message portion;
to include signalling data in the first field of the message portion, the signalling data being for indicating a type of the motion data included in the second field; and
to cause the message portion to be transmitted wirelessly to a recipient device.

38. The apparatus of claim 37, the computer-readable code together with the at least one processor causing the apparatus:
to detect a change in the at least one signal generated by the at least one motion sensor; and
to respond to the detection by: including the motion data in the second field; including the signalling data in the first field; and causing the message portion to be transmitted to the recipient device.

39. The apparatus of claim 37, the computer-readable code together with the at least one processor causing the apparatus:
to respond to receipt of a request from the recipient device by: including the motion data in the second field; including the signalling data in the first field; and causing the message portion to be transmitted to the recipient device.

40. The apparatus of claim 37, wherein the signalling data is configured to indicate a number of axes of motion to which the motion data relates.

41. The apparatus of claim 37, wherein the motion data comprises plural types of motion data, the plural types of motion data being based on signals generated by plural types of motion sensor, and wherein the signalling data is configured to indicate the types and locations in the second field of each of the plural types of motion data.

42. The apparatus of claim 41, wherein the signalling data comprises plural pairs of data bits, each pair of data bits corresponding to a different type of motion data.

43. The apparatus of claim 42, wherein each pair of data bits for indicating a number of axes of motion to which the corresponding type of motion data relates.

44. The apparatus of any of claim 41, wherein the plural types of motion data comprise to at least two of an accelerometer motion data type, a gyroscope motion data type and a magnetometer motion data type.

45. Apparatus comprising at least one processor and at least one non-transitory memory medium having computer-readable code stored thereon, the computer-readable code together with the at least one processor causing the apparatus:
to enable wireless receipt from a motion detection device of a message portion, the message portion including a first field and a second field, the second field including motion data indicative of motion of the motion detection device and the first field including signalling data for indicating a type of the motion data included in the second field; and
to use the signalling data to interpret the motion data.

46. The apparatus of claim 45, the computer-readable code together with the at least one processor causing the apparatus:
prior to enabling wireless receipt of the message portion, to cause transmission to the motion detection device of a request for motion data indicative of the motion of the motion detection device.

47. The apparatus of claim 45, wherein the signalling data is configured to indicate a number of axes of motion to which the motion data relates.

48. The apparatus of claim 45, wherein the motion data comprises plural types of motion data, the plural types of motion data being based on signals generated by plural types of motion sensor, and wherein the signalling data is interpreted to derive the types and locations in the second field of each of the plural types of motion data.

49. The apparatus of claim 48, wherein the plural types of motion data comprise to at least two of an accelerometer motion data type, a gyroscope motion data type and a magnetometer motion data type.

50. The apparatus of claim 45, wherein the signalling data comprises plural pairs of data bits, each pair of data bits corresponding to a different type of motion data.

51. The apparatus of claim 50, wherein each pair of data bits for indicating a number of axes of motion to which the corresponding type of motion data relates.

52. A method comprising:
including motion data based on at least one signal generated by at least one motion sensor in a message portion, the message portion comprising a first field and a second field, the motion data being included in the second field of the message portion;
including signalling data in the first field of the message portion, the signalling data being for indicating a type of the motion data included in the second field; and
causing the message portion to be transmitted wirelessly to a recipient device.

53. The method of claim 52 further comprising:
responding to the detection of at least one of a detected change in the signal generated by the at least one motion sensor and a receipt of a request from the recipient device by: including the motion data in the second field; including the signalling data in the first field; and causing the message portion to be transmitted to the recipient device.

54. The method of claim 52 further comprising:
indicating in the signalling data a number of axes of motion to which the motion data relates.

55. The method of claim 52, wherein the motion data comprises plural types of motion data, the plural types of motion data being based on signals generated by plural types of motion sensor; and
indicating in the signalling data the types and locations in the second field of each of the plural types of motion data.

56. The method of claim 52, wherein the signalling data comprises plural pairs of data bits, each pair of data bits corresponding to a different type of motion data; and
indicating in each pair of data bits a number of axes of motion to which the corresponding type of motion data relates.
